(19) United States
(12) Patent Application Publication
(10) Pub. No.: US 2003/0133021 A1
(43) Pub. Date: Jul. 17, 2003

(54) CAMERA HAVING IMPROVED IMAGE QUALITY

(76) Inventors: TOSHIHIRO HAMAMURA, OSAKA (JP); HIROAKI KUBO, MUKO-SHI (JP)

Correspondence Address: SIDLEY AUSTIN BROWN & WOOD LLP, 717 NORTH HARWOOD, SUITE 3400, DALLAS, TX, 75201, US

(21) Appl. No.: 09/120,761

(22) Filed: Jul. 22, 1998

(30) Foreign Application Priority Data
Jul. 24, 1997 (JP) HEI 9-198619

(51) Int. Cl. H04N 5/222

(52) U.S. Cl. 348/229.1; 348/371

(57) ABSTRACT

Under exposure determination unit 212 determines whether or not there is under exposure during exposure set using a hand vibration time limit. When a suitable exposure time is longer than the hand vibration time limit, the exposure time is increased by increasing the gain set for the hand vibration time limit. When a flash is used, the distance the emitted light of the flash must reach is determined from the flash guide number and open aperture value, and a determination is made as to whether or not the light emitted by the flash will reach the photographic subject. Under exposure is determined when the distance to the photographic subject is longer than the distance attained by the light emitted from the flash, and the gain is adjusted in accordance therewith.

This application is based on application No. HEI 9-198619 filed in Japan, the content of which is hereby incorporated by reference.

### BACKGROUND OF THE INVENTION

1. Field of the Invention

The present invention relates to a camera for taking an object image using an image sensor having photoelectric conversion elements, amplifying the obtained image signals, and thereafter processing or storing in memory the obtained image signals.

2. Description of the Related Art

Conventional still cameras are known which are provided with image sensing means using a charge-coupled devices (CCD) in a two-dimensional array. Such cameras receive the light reflected by a photographic subject and manage the electrical signals at levels corresponding to the amount of light as image signals. When taking a photograph, the aperture value and exposure time (shutter speed) are set for the CCD based on the luminance of the photographic subject, and the photograph is taken in an exposure state corrected by controlling the settings to open the aperture and lengthen the exposure time in accordance with reduced luminance of the photographic subject. Image signals read by the image sensing means are amplified to a desired level via an amplification circuit, and subsequently transmitted to a processing unit in a later stage.

Japanese Laid-Open Patent Application No. SHO 59-099880A discloses a photographic device provided with an amplification circuit comprising an automatic gain control circuit (AGC) for amplifying the output of the image sensing means by a desired gain. In the case of photographic subjects having low luminance, this photographic device fixes the AGC gain at a predetermined value by controlling flash emission so as to stop the flash at the moment a suitable exposure has been attained, thereby being capable of producing suitable photographs even with flash photography.

When the exposure time is lengthened when taking a photograph due to low luminance of the photographic subject, hand vibrations readily occur which cause blurring of the subject. In conventional still cameras, there is no consideration given to hand vibration because the exposure time is merely set relative to the luminance of the photographic subject. Therefore, it is disadvantageously unavoidable that reduced image quality may result in accordance with the luminance of the photographic subject.

In the photographic device disclosed in Japanese Laid-Open Patent Application No. SHO 59-099880A, the range of the flash device is limited, such that the flash may not adequately reach a photographic subject depending on the distance to the subject, with the result that it is difficult to normally achieve suitable image quality in photographs even when using an AGC.

### SUMMARY OF THE INVENTION

In view of the aforethe information an object of the present invention is to provide a camera capable of suppressing a reduction in image quality at least by increasing the benefit of the amplification circuit for amplifying the read image signals when the luminance of a subject is ultimately insufficient.

A further object of the present invention is to provide a camera capable of taking images using a suitable exposure in accordance with the distance to a subject when using a flash.

### BRIEF DESCRIPTION OF THE DRAWINGS

These and other objects and features of this invention will become clear from the following description, taken in conjunction with the preferred embodiments with reference to the accompanied drawings in which:

FIG. 1 is a block diagram briefly showing an still camera of an embodiment of the present invention;

FIG. 2 is a flow chart showing the operation of the still camera;

FIG. 3 is a flow chart showing the S1 subroutine;

FIG. 4 is a flow chart showing the FLASH OFF subroutine; and

FIG. 5 is a flow chart showing the FLASH ON subroutine.

### DETAILED DESCRIPTION OF THE PREFERRED EMBODIMENTS

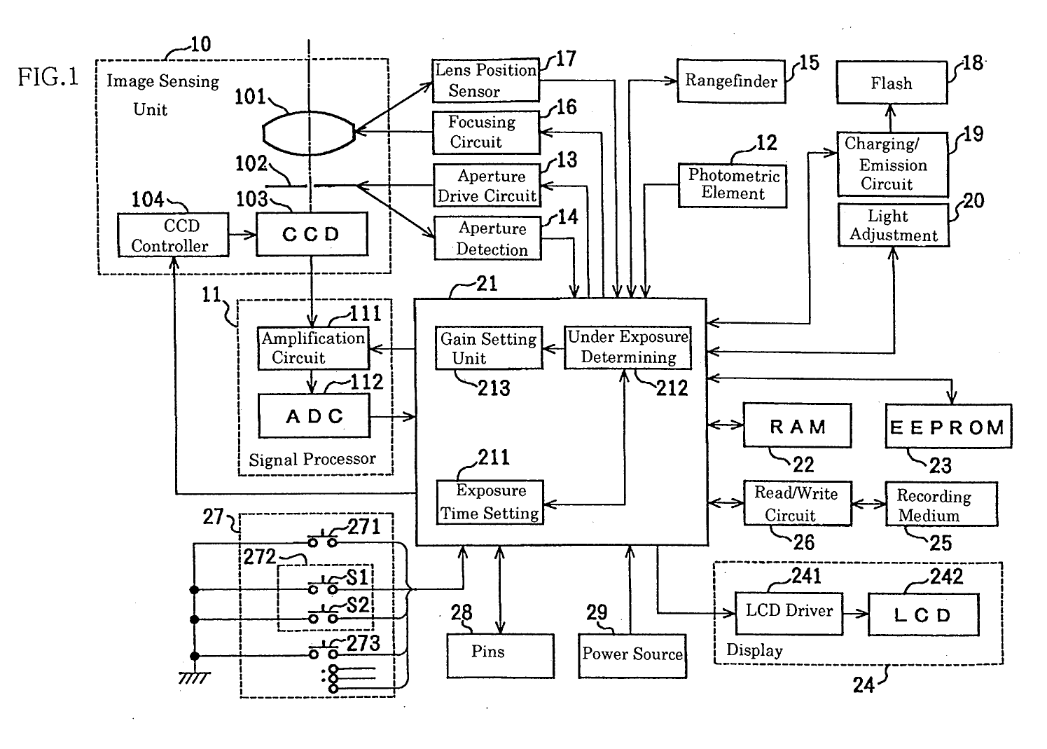

FIG. 1 is a block diagram briefly showing an still camera of an embodiment of the present invention.

In FIG. 1, image sensing unit 10 comprises a taking lens 101, aperture stop 102, CCD 103, and CCD controller 104, and manages a photographic subject image as image signals. Image sensing unit 101 forms an image on the photoreceptive surface of CCD 103 via light from a photographic subject. Aperture stop 102 adjusts the amount of light received by CCD 103. CCD 103 comprises a plurality of photoelectric conversion elements disposed in a two-dimensional array, the anterior surface of which is provided with a color filter of the single panel type, and which receives the light of the photographic image formed by the taking lens 101 and produces electric signal of three primary colors (RGB) in accordance with the amount of received light. CCD controller 104 controls CCD 103 so as to perform a light receiving operation when a predetermined load has accumulated, and transmits pixel signals from each photoelectric conversion element obtained by the light receiving operation to the signal processor 11. The aforethe predetermined load accumulation time is set by a microprocessor unit (MPU) 21 described later. Aperture stop 102 may be constructed as a plurality of aperture blades capable of setting sequential aperture values by using an instant SLR camera lens or the like, or a roulette type aperture capable of setting aperture values in stages by rotating a wheel having diaphragm holes of a plurality of sizes and types.

Signal processor 11 comprises an amplification circuit 111 for amplifying the pixel signals transmitted from the CCD 103 by a predetermined gain, and an analog-to-digital converter (ADC) 112 for converting the amplified pixel signals to digital pixel data. The gain of the amplification circuit 111 is set by MPU 21.

Photometric element 12 is an exposure meter which utilizes a photosensor such as cadmium sulfide (CdS) or the like, and measures the light received from the photographic subject. Signals obtained by photometry are managed by MPU 21 as photometry data. Aperture drive circuit 13 drives the rotation of aperture stop 102 at a diaphragm position corresponding to a control aperture value. Aperture detection sensor 14 is an encoder or the like for detecting the aperture position of aperture stop 102, and outputs detected aperture detection information to MPU 21.

Rangefinder module 15 is a passive external light module comprising a pair of line sensors or the like for receiving light from a photographic subject. Rangefinder module 15 receives the light from a subject image via a pair of line sensors or the like in conjunction with a rangefinding instruction from MPU 21, and determines measurement data corresponding to the distance to a photographic subject from the amount of dislocation of the subject image between both the line sensors. The measurement data are managed by MPU 21. Focusing circuit 16 drives taking lens 101 to a focus position in accordance with the defocus amount received from MPU 21. Lens position sensor 17 is an encoder or the like which detects the position of taking lens 101, and outputs the detected lens position information to MPU 21. Rangefinder module 15 is not limited to the aforethe passive external light type, and may be an active type comprising a light-emitting diode (LED) and position sensing device (PSD) which receives the light of the LED reflected from a photographic subject, which obtains rangefinding information corresponding to the distance to a photographic object in accordance with the amount of light received by the PSD.

Flash 18 comprises a white light source such as a xenon (Xe) tube or the like. Charging/emission circuit 19 is provided with a charging condenser (not illustrated), which starts charging when charging instruction is received from MPU 21, and supplies the charged power to flash 18 for flash emission when a trigger signal is received from MPU 21. Light adjustment circuit IC 20 receives a modulation start signals from MPU 21, and begins monitoring the amount of light emitted by flash 18 and reflected by the photographic subject, and transmits a flash emission stop signal to MPU 21 at the moment the amount of light being monitored attains a suitable exposure corresponding to the gain set in amplification circuit 111. When the flash stop signal is transmitted, the charged power supplied from charging/emission circuit 19 to the flash 18 is stopped.

MPU 21 comprises an exposure time setting unit 211, under exposure determining unit 212, and gain setting unit 213, and executes general control of the still camera.

Random access memory (RAM) 22 is used as the working area for MPU 21. Erasable programmable read only memory (EEPROM) stores still camera setting information, conversion data for converting photometric data to photographic luminance (e.g., table type conversion coefficients, conversion type coefficients and the like), focal length information corresponding to range data, flash photography white balance values, flash GNo corresponding to various gain levels set for 1×, 2×, and 4× for amplification circuit 111, and aperture values.

MPU 21 monitors the operational state of the various switches of operation switch complex 27, to control the execution of processes specified by the operated switches. MPU 21 compares the count value of an internal timer with a predetermined value (e.g., number of minutes), and determines whether or not to stop the power supply from power source 29 to various components. MPU 21 then determines whether or not the voltage of the charging condenser of charging/emission circuit 19 is less than a standard level.

MPU 21 converts photometric data from photometric element 12 to photographic subject luminance using conversion data stored in EEPROM 23, and calculates a control aperture value from the subject luminance. This control aperture value may be calculated using the subject luminance, or a control aperture value corresponding to a subject luminance may be selected from a predetermined table of values. MPU 21 monitors the aperture position information from aperture position sensor 14 in conjunction with the control aperture value, and controls the aperture drive circuit 13 so as to drive aperture stop 102 to an aperture position corresponding to the control aperture value.

MPU 21 calculates the amount of defocus of the taking lens 101 from the focal length data stored in EEPROM 23 and the range data from rangefinder module 15. MPU 21 monitors the lens position information received from lens position sensor 17 in conjunction with the amount of defocus, and controls focusing circuit 16 so as to drive the taking lens 101 to the focus position.

MPU 21 executes predetermined image processing for image data received from ADC 112 (i.e., black level correction, white level correction, white balance adjustment, image interpolation processing, halftone correction via lookup table, and image compression such as JPEG and the like).

Exposure time setting unit 211 sets the exposure time of CCD 103 and outputs the time to the CCD control circuit 104. That is, when flash 18 is not emitting light, the exposure time is initialized by a predetermined method. For example, the initialized exposure time may be set at a predetermined value in the case of a sequentially variable aperture, and similar to automatic exposure control (AE) may be set at a suitable exposure together with the control aperture value in conjunction with subject luminance. The exposure time is then set to a suitable exposure value determined from the luminance level of the obtained image data. When this suitable exposure time is longer than the hand vibration time limit (T LMT), the exposure time is to the hand vibration time limit. The hand vibration time limit is the time during which hand vibration does not affect the subject image; e.g., when the focal length of taking lens 101 is designated f (mm), the hand vibration time limit is 1/f (sec). When the flash 18 is used, the exposure time setting unit 211 sets the exposure time at the hand vibration time limit. Accordingly, in the present embodiment, the exposure time when taking a photograph is set less than the hand vibration time limit regardless of whether or not the flash 18 is used.

When flash 18 is used, under exposure determining unit 212 determines whether or not there is under exposure using the range data from rangefinder module 15, open aperture value, and guide No. (GNo) of flash 18 relative to the gain set by amplification circuit 111. That is, under exposure determining unit 212 divides the GNo value of flash 18 relative to the gain of amplification circuit 111 by the open aperture value, and determined under exposure if the distance to the photographic subject indicated by the range data from rangefinder module 15 is greater than the quotient.

In contrast, when flash 18 is not used, the under exposure determining unit 212 determines whether or not there is under exposure using the hand vibration time limit. That is, since the exposure time when taking a photograph is set so as to be less than the hand vibration time limit in the present embodiment, under exposure is determined when the determined suitable exposure time is greater than the hand vibration time limit. Therefore, the under exposure determining unit 212 determines whether or not the suitable exposure time is greater than the hand vibration time limit.

Gain setting unit 213 sets the gain for amplification circuit 111. When flash 18 is not used, the gain of amplification circuit 111 is set at 1× a predetermined gain. When the under exposure determining unit 212 determines that the exposure time set by the exposure time setting unit 211 is greater than the hand vibration time limit, the gain of amplification circuit 111 is increased to 2×. In this way, the predetermined gain set by the amplification circuit 111 is increased from 1× to 2× and 4× for each exposure operation of CCD 103. Conversely, when flash 18 is used, gain setting unit 213 sets the gain of amplification circuit 111 at 1× a predetermined gain, and when under exposure is determined by under exposure determining unit 212, the gain of amplification circuit 111 is increased 2× or 4×.

Exposure time setting unit 211 and gain setting unit 213 may set the exposure time and gain so as to achieve uniform integrated values for exposure time and gain. In this way, uniform photographic image quality can be maintained even when the exposure time varies.

Display 24 comprises a liquid crystal display panel (LCD) driver 241 and LCD 242. LCD driver 241 displays image data and written information from MPU 21 on LCD 242.

Recording medium 25 comprises a semiconductor recording element or the like such as an integrated circuit (IC) memory card or disk for storing magnetic or magneto optic data, and is removably installed in the still camera. Recording medium 25 stores data such as self type and remaining storage capacity. Read/write circuit 26 reads and writes data from/to recording medium 25. MPU 21 determines whether or not recording medium 25 is installed by reading therefrom via read/write circuit 26. That is, MPU 21 determines that recording medium 25 is installed in the still camera if read/write circuit 26 can read out data from the medium, and determines the recording medium 25 is not installed if data cannot be read therefrom.

Operation switch complex 27 comprises a plurality of switches including power source switch 271, release switch 272, and flash mode switch 273. Release switch 272 executes the photographic preparation operation when the switch S1 is depressed halfway, and executes the photographic operation when switches S1 and S2 are fully depressed. Flash mode switch 273 selects a mode from among flash mode, auto-flash mode, and normal light (non-flash) mode.

External pins 28 are used to connect the still camera to an external device such as a personal computer, printer or the like, and transmits photographic image data to the external device. Power source 29 is a secondary power battery for supplying power to various circuits and drive units.

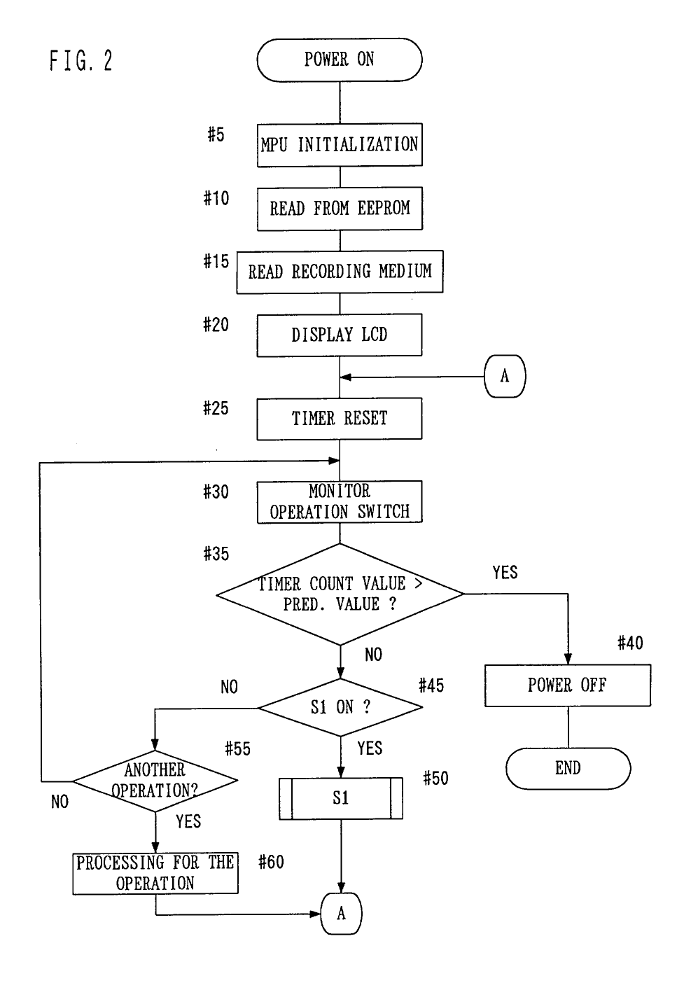

FIG. 2 is a flow chart of the operation of the still camera.

When power switch 271 is turned ON, power is supplied from power source 29 to various components, and MPU 21 is subject to reset operation and internal initialization (step #5). Previously set information is then read out from EEPROM 23, and MPU 21 sets the conditions specified by the information (step #10).

Then, data specifying the type and remaining capacity of recording medium 25 are read via read/write circuit 26 (step #15). At this time, a determination is made as to whether or not recording medium 25 is installed in the still camera based on whether or not data can be read out from recording medium 25. The information obtained from EEPROM 23 and recording medium 25 is displayed on LCD 242 (step #20). Thereafter, the timer count value is reset (step #25), and the operating states of the various switches of operation switch complex 27 are monitored (step #30).

Then, a determination is made as to whether or not the timer count value has exceeded a predetermined value (step #35). When the predetermined value has been exceeded, the current setting information is stored in EEPROM 23, and the power supply to various components other than MPU 21 is stopped as necessary to detect the ON operation of power switch 271 (step #40), and the processes of this flow chart end.

When the counter value has not exceeded the predetermined value in step #35, a check is made to determined whether or not release switch 27 has been depressed halfway to turn switch S1 ON during the monitoring in step #30, (step #45). When switch S1 is ON, the switch S1 subroutine (described later) is executed (step #50), and the program returns to step #25.

When it is determined that switch S1 is not ON, a check is made to determine whether or not there has been a switch operation other than release switch 272 in switch complex 29 during the monitoring of step #30 (step #55). When there has been other switch operation, processing is executed as specified for the operated switch (step #60), and the program returns to step #25. If it is determined in step #55 that other switch operation has not occurred, the program returns to step #30.

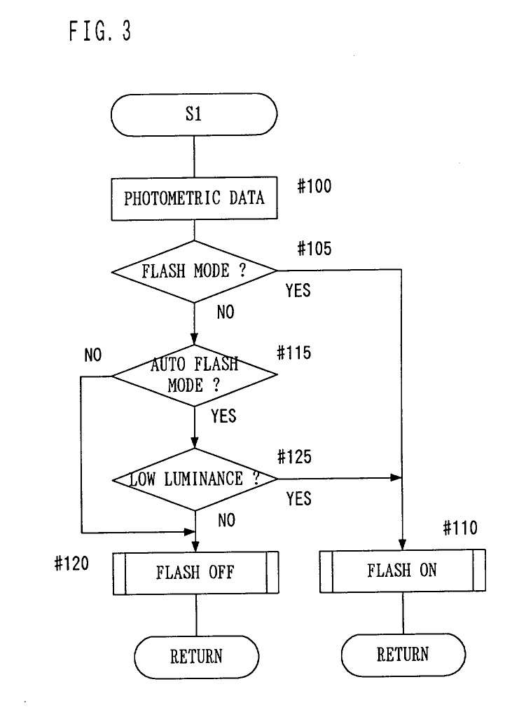

FIG. 3 is a flow chart of the switch S1 subroutine. When the S1 subroutine is called, MPU 21 converts photometric data from photometric element 12 to photographic subject luminance via conversion data stored in EEPROM 23 (step #100).

Thereafter, a check is made to determine whether or not the flash mode switch 273 in switch complex 27 has been operated to select the flash mode during the monitoring of step #30 of FIG. 1 (step #105). When it is determined that the flash mode has been selected, the FLASH ON subroutine (described later) is executed (step #110).

When it is determined in step #105 that the flash mode has not been selected, a check is made to determine whether or not flash mode switch 273 has been operated to select the auto flash mode (step #115). When it is determined that the autoflash mode has not been selected, the FLASH OFF subroutine (described later) is executed (step #120). When it is determined that the auto flash mode has been selected, a determination is made as to whether or not the photographic subject luminance obtained in step #110 is less than a predetermined luminance (step #125). When the luminance is determined to be less than a predetermined luminance value, the process continues to step #110, whereas if the luminance is equal to or greater than a predetermined luminance value, the process advances to step #120.

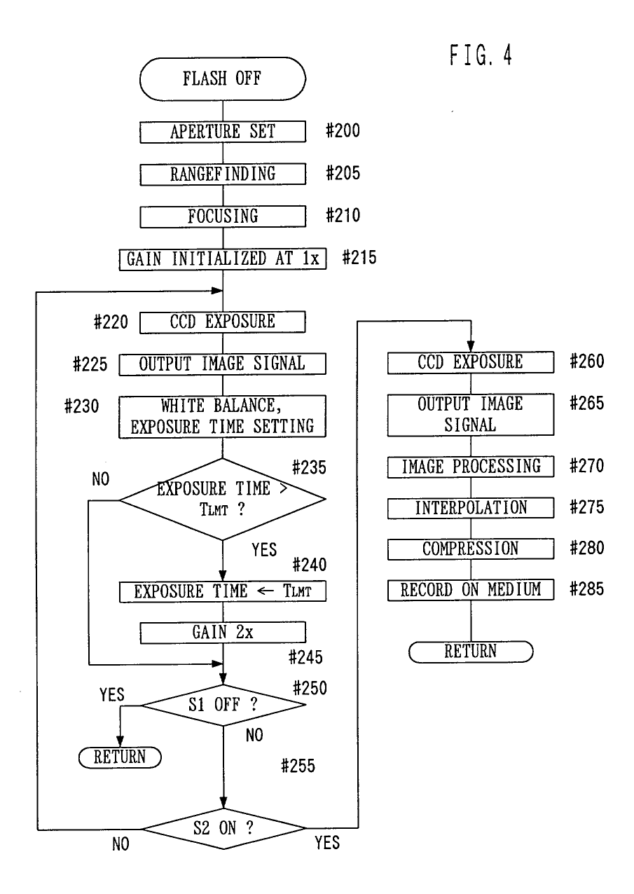

FIG. 4 is a flow chart of the FLASH OFF subroutine. When the FLASH OFF subroutine is called, MPU 21 determines the control aperture value corresponding to the subject luminance obtained in step #100, and controls the aperture drive circuit 13 while monitoring the aperture position information received from aperture position sensor 17 in accordance with the control aperture value. Aperture stop 102 is driven to the aperture position of the control aperture value via the drive provided by the aperture drive circuit 13 (step #200).

Then, a rangefinding command is transmitted from MPU 21 to rangefinding module 15, and range data are determined (step #205). MPU 21 determines the amount of defocus from the focal length data corresponding to the rage data, and controls the drive of the focusing circuit 16 in conjunction with the amount of defocus while monitoring lens position information of lens position sensor 17. The taking lens 101 is thus moved to the focus position by driving the focusing circuit 16 (step #210). Then, the gain of amplification circuit 111 is initialized at 1× a predetermined gain (step #215).

Thereafter, the exposure time is set using a predetermined method via the exposure time setting unit 211, and CCD 103 executes exposure in accordance with the set exposure time (integral time) (step #220). When exposure ends, image signals are output from CCD 103 (step #225), and transmitted to signal processor 11. These image signals are amplified by set gain by amplification circuit 111, and subjected to A/D conversion by ADC 112 to obtain image data. After these image data are temporarily stored in RAM 22, they are subjected to black level correction and white level correction, and white balance adjustment. Thereafter, image data are read out from RAM 22 and the photographic image is displayed (previewed) on LCD 242. A suitable exposure time is determined based on the luminance level of the obtained image data (step #230).

Then, a determination is made as to whether or not the suitable exposure time is longer than the hand vibration time limit (step #235). When the suitable exposure time is longer than the hand vibration time limit, the exposure time is set at the hand vibration time limit (step #240). At this time, the gain of amplification circuit 111 is set at 2× a predetermined gain (step #245).

After this increase, or when the suitable exposure time is determined to be less than the hand vibration time limit in step #235, a check is made to determined whether or not switch S1 of switch complex 27 is OFF (step #250). When switch S1 is determined to be OFF, the processes of the FLASH OFF subroutine and S1 subroutine end, and the program returns to step #25 of FIG. 2.

When it is determined in step #250 that switch S1 is not OFF, a further check is made to determine whether or not switch S2 of switch complex 27 is ON (step #255). When it is determined that switch S2 is not ON, the program returns to step #220. In this way, the processes of steps #220 through #250 are repeated, suitable white balance is adjusted in step #230, and the gain of amplification circuit 111 is increased to a suitable value in step #245. That is, when the gain of amplification circuit 111 is increased to 2× a predetermined gain in step #245 and the exposure time determined in step #230 is equal to or shorter than the hand vibration time limit rather than longer than the time limit via the repeated processes, the process sequence of steps #240 and #245 are skipped, and the previously set gain is maintained, such that a suitable gain is set relative to the exposure time set at the hand vibration time limit.

When it is determined in step #255 that switch S2 is ON, the obtained suitable exposure time is output to CCD control circuit 104, and CCD 103 executes exposure for the suitable exposure time (step #260). When exposure ends, image signals are output from CCD 103 (step #265), and transmitted to signal processor 11.

The obtained image signals are amplified by amplification circuit 111 by the gain set in step #215 or #245, and subjected to A/D conversion by ADC 112 to obtain digital image data. After these image data are stored in RAM 22, black level correction and white level correction and white balance adjustment are executed(step #270), and an image correction process is executed via interpolation (step #275). Thereafter, image data are read out from RAM 22, and a photographic image is displayed (after view) on LCD 242. The image data stored in RAM 22 are subjected to image compression processing such as JPEG or the like (step #280), and recorded on recording medium 25 via read/write circuit 26 (step #285). Thereafter, the processes of the FLASH OFF subroutine and S1 subroutine end, and the program returns to step #25 of FIG. 2.

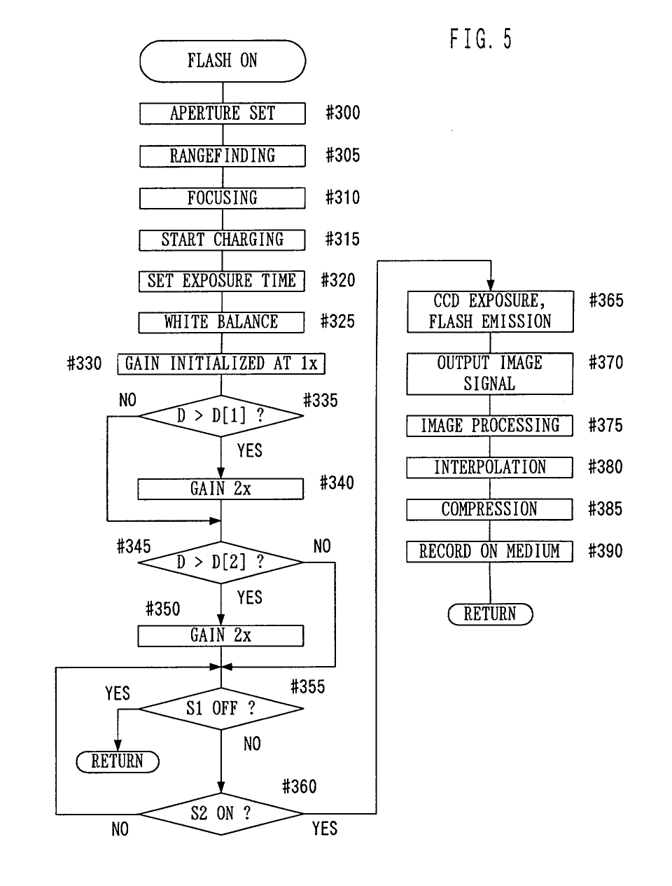

FIG. 5 is a flow chart of the FLASH ON subroutine.

When the FLASH ON subroutine is called, MPU 21 determines the control aperture value for the open aperture, and drives the aperture drive circuit 13 in conjunction with this control aperture value while monitoring the aperture position information from aperture position sensor 14. Aperture stop 102 is thus driven to the open aperture position by the drive provided by aperture drive circuit 13 (step #300).

Then, a rangefinding command is transmitted from MPU 21 to rangefinding module 15, and range data are determined (step #305). MPU 21 determines the amount of defocus from the focal length data corresponding to the range data, and drives the focusing circuit 16 while monitoring the lens position information from the lens position sensor 17. Thus, the taking lens 101 is moved to the focus position by driving the focusing circuit 16 (step #310).

MPU 21 then determines whether or not the voltage of the charging condenser of the charging/emission circuit 19 is less than a predetermined standard level, and if the voltage is lower than the predetermined standard level, a charge command is transmitted to the charging/emission circuit 19 to start charging (step #315).

Thereafter, the exposure time is set at the hand vibration time limit by exposure time setting unit 211 (step #320). White balance is adjusted and set in accordance with the white balance value set for flash operation stored in EEPROM 23 (step #325). The gain of amplification circuit 111 is set at 1× a predetermined gain by gain setting unit 213 (step #330), and light adjustment circuit IC 20 is alerted to the 1× gain exposure.

Under exposure determining unit 212 reads from EEPROM 23 the guide number GNo [1] from flash 18 corresponding to the gain of amplification circuit 111, and divides the GNo [1] value by the open aperture value to obtain a flash emission effective for distance D [1]. Then, a determination is made as to whether or not the distance D to the photographic subject expressed by the range data determined in step S305 is longer than the distance D[1] (step #335). When the distance D is determined to be longer than the distance D[1], the gain of amplification circuit 111 is increased to 2× a predetermined gain by gain setting unit 213 (step #340), and light adjustment circuit IC 20 is alerted to the 2× gain exposure.

After this alert or when it is determined that the distance D is not longer than the distance D[1] in step #335, the under exposure determining unit 212 reads out from EEPROM 23 the GNo [2] value of flash 18 corresponding to the gain of amplification circuit 111, and divides the value GNo [2] by the open aperture value to obtain distance D[2]. Then, a check is made to determined whether or not the distance D to the photographic subject is longer than the distance D[2] (step #345). When the distance D is longer than the distance D[2], the gain of amplification circuit 111 is increased to 2× the previously doubled gain (i.e., 4× total gain), and light adjustment circuit IC 20 is alerted to the total 4× increased gain exposure.

After the alert of 4× gain or when it is determined that the distance D is not longer than the distance D[2] in step #345, a check is made to determine whether or not the switch S1 of switch complex 27 is OFF (step #355). If it is determined that switch S1 is OFF, the processes of the FLASH ON subroutine and S1 subroutine end, and the program returns to step #35 of FIG. 2.

When it is determined that switch S1 is not OFF in step #355, a check is made to determine whether or not switch S2 of switch complex 27 is ON (step #360). When it is determined that switch S2 is not ON, the program returns to step #355.

When it is determined that switch S2 is ON in step #360, the exposure time set in step #320 is output to CCD control circuit 104, and exposure is executed for the set exposure time. During this exposure, a modulation start signal is output to light adjustment circuit IC 20, and the amount of light emitted by flash 18 and reflected by the photographic subject is monitored, and directly after monitoring starts a trigger signal is output to charging/emission circuit 19, and flash 18 emits a flash. At the moment the amount of light attains a suitable amount corresponding to the gain indicated during the monitoring, and a flash stop signal is generated. When this flash stop signal is generated, the supply of charging power to flash 18 is stopped by the charging/emission circuit 19. Thus, the emission of flash 18 ends. Thereafter, the exposure time ends (step #365).

Then, the image signals are output from CCD 103 (step #370), and transmitted to signal processor 11.

These image signals are amplified by amplification circuit 111 by the gain set in either step #330, 340, or 350, and subjected to A/D conversion by ADC 112 to obtain image data. After these image data are stored in RAM 22, black level correction and white level correction are executed and white balance adjustment is accomplished in accordance with the white balance value set in step #325 (step #375), and an image correction process is executed via interpolation (step #380). Thereafter, image data are read out from RAM 22, and a photographic image is displayed (after view) on LCD 242. The image data stored in RAM 22 are subjected to image compression processing such as JPEG or the like (step #385), and recorded on recording medium 25 via read/write circuit 26 (step #390). Thereafter, the processes of the FLASH ON subroutine and S1 subroutine end, and the program returns to step #35 of FIG. 2.

As described above, the exposure time is set at less than the hand vibration time limit regardless of whether or not flash 18 is used, and when under exposure is determined by the under exposure determining unit 212, the gain of amplification circuit 111 is increased by the gain setting unit 213. As a result, vibration of the photographic subject due to hand vibration is suppressed, and photographed image data are obtained at an excellent exposure level.

Obviously, many modifications and variation of the present invention are possible in light of the above teachings. It is therefore to be understood that within the scope of the appended claims, the invention may be practiced other than as specifically described.

What is claimed is:

1. A camera comprising:
an image sensing device having photoelectric conversion elements for receiving light from a subject;
an amplifier for amplifying a signal output from said image sensing device by a predetermined gain;
a photometer for measuring the luminance of said subject;
an exposure time determining portion for determining the exposure time of said photoelectric conversion elements via an output of said photometer; and
a changer for comparing said exposure time with a predetermined time and changing an exposure time and gain in accordance with a result of said comparison.

2. A camera as claimed in claim 1, wherein said changer sets the exposure time as the predetermined time when the exposure time is longer than the predetermined time.

3. A camera as claimed in claim 2, wherein said changer increases the gain.

4. A camera as claimed in claim 1, wherein said changer changes the gain in accordance with a difference between the exposure time and the predetermined time.

5. A camera as claimed in claim 1, wherein said camera operates the image sensing device in accordance with the exposure time and gain changed by the changer.

6. A camera comprises:
an image sensing device having photoelectric conversion elements for receiving light from a subject;
an amplifier for amplifying a signals output from said image sensing device by a predetermined gain;
a rangefinder for measuring the distance to said subject;
an illumination device for illuminating said subject when said image sensing device operates;
a determination portion for determining whether or not the light emitted by said illumination device reaches said subject; and
a controller for controlling the gain when the result of said determination is that the illumination light does not reach said subject.

7. A camera as claimed in claim 6, wherein said controller controls the gain in accordance with an information obtained by said rangefinder.

8. A camera as claimed in claim 6, wherein said camera operates the image sensing device in accordance with the gain controlled by the controller.

9. A signal processing method in an apparatus having an image sensor, comprising:
a amplifying step of amplifying a signal output from the image sensor by a predetermined gain;
a comparing step of comparing an exposure time of said image sensor with a predetermined time; and
a changing step of changing the exposure time and gain in accordance with a result of said comparison.

10. A signal processing method as claimed in claim 9, wherein said changing step sets the exposure time as the predetermined time when the exposure time is longer than the predetermined time.

11. A signal processing method as claimed in claim 9, wherein said changing step changes the gain in accordance with a difference between the exposure time and the predetermined time.

12. A signal processing method as claimed in claim 9, wherein said image sensor is operated in accordance with the exposure time and gain changed in the changing step.
